(19) United States
(12) Patent Application Publication
(10) Pub. No.: US 2025/0292214 A1
(43) Pub. Date: Sep. 18, 2025

(54) SYSTEM AND METHOD FOR MATCHING, SCHEDULING, AND PERFORMING OTHER ADMINISTRATIVE TASKS FOR SPORTS

(71) Applicant: Todd Sniper, Portland, ME (US)

(72) Inventor: Todd Sniper, Portland, ME (US)

(21) Appl. No.: 18/608,168

(22) Filed: Mar. 18, 2024

(51) Int. Cl. G06Q 10/1093

(52) U.S. Cl. CPC G06Q 10/1097

(57) ABSTRACT

A system and method for matching, tracking, and connecting sports teams. The system provides searchable or system-generated suggested matches with other teams for games, scrimmages, and other activities. The system also provides functions for searchable or suggested referees, facility bookings, and other functions. The system and method include the collection of sports data for teams such as record, roster, location, schedule, availability, division, and other attributes. The team attributes can be used to track standings, schedule games with other teams, request referees or umpires, check and reserve arenas, fields, rinks, or other sports grounds, and complete other administrative tasks associated with coordination and running of a sports team.

### BACKGROUND OF THE INVENTION

### 1. Field of the Invention

The present invention relates generally to a mobile phone application. More particularly, the present invention is a method and system for facilitating team sport activities and administrative tasks. Still more particularly, the present invention relates to a mobile phone application system and method in which a user can select, contact, and schedule matches, referee requests, status of fields, and more.

### 2. Description of the Prior Art

The prevalence, use, and functionality of mobile phone applications continues to increase. Mobile phone applications provide the basis for much of what is done remotely on a phone. As the functionality and utility of these applications improve, the demand also increases. Mobile phone applications offer a wide range of uses and services.

Existing mobile phone applications have continued to develop in utility, complexity, and offerings; however, existing mobile phone applications have some limitations. For example, many applications may offer a use or service, but may not have all the features required by the user. Additionally, the use of the application and services provided by the application may not align with the exact needs of the user. Still further, the applications may lack the ability to be integrated to other mobile phone applications or other aspects of the user's life. This may cause issues with collection, organization, management, and access of data.

Although various types of sports teams and activities have existed for a long time, administration of the teams, rosters, leagues, and other tasks required to properly run a team require significant time, effort, and investment from coaches and administrators. Administrators must keep up-to-date rosters and contact information for players, find suitable opponents, secure a field or facility in which to play, coordinate and pay referees, and complete many other tasks to ensure the running of a team is smooth and efficient.

Currently, this takes significant time and effort to align the multiple variables into a workable schedule. Often times, scheduling is an issue because of referee or field/facility availability. There may also be issues finding appropriate opponents for matches due to age differences, talent differences, location, or other factors. Additionally, even if an opponent, field, and referee are secured, coordination and communication of the team is still difficult with the need to reach out to each player or parents of players with text messages, calls, facilitation of transportation, and other logistical issues. This often leads to various issues including inappropriately matched teams, failure to secure a referee or facility, or both, miscommunications, and other difficulties.

What is needed is a method and system for coordinating the various administrative tasks required to direct and oversee a sports team. What is needed is a mobile application which collects, analyzes, organizes, and presents data related to such administrative tasks. What is further needed is a mobile application which utilizes this data to then identify and select opponents, manage communications to players, parents, or other contacts, select or pay referees, book or pay for facility use, and complete other tasks related to running a sports team.

### SUMMARY OF THE INVENTION

The present invention addresses these and other needs by providing a novel mobile phone application that collects and presents sortable and selectable sports team characteristics or preferences. The application utilizes such features to improve efficiency, reduce time and effort requirements of administrators, and improve the quality of information available to administrators.

Additionally, the present invention provides a user-friendly interface that further enhances the usability and performance of the application. The interface is designed to quickly and easily collect, store, and organize information about a user's team. The interface is also designed to suggest or identify appropriate matches or teams, referees, facilities, and other services that may fit a user's team's needs or profile characteristics.

It is to be understood that both the foregoing general description and the following detailed description are exemplary and explanatory only and are not restrictive of the invention, as claimed.

It is an object of the present invention to provide a system and method that collects, stores, organizes, optimizes, and presents data sets in order to facilitate the easy, comprehensive, and efficient administration of a sports team. The information includes a variety of information including but not limited to team information, player information, referee information, field and facility information, and more. The information collected and stored by the present invention may be used for a wide variety of purposes related to the administration of a team. This includes, but is not limited to, finding and selecting suitable opponents, finding and selecting referees, checking field or facility availability and locations, selectively allowing communication to users, players, parents, coaches, administrators, or other individuals, and other functions.

The present invention collects volunteered data from users to build a database of players, rosters, teams, locations, and other information. Users may include players, coaches, administrators, referees, town, state, or federal officials, and other individuals. User information is provided such as name, address (or more general location), sport, age, availability, and other pertinent information. The user may manage their account and update information as necessary. The present invention may also update individual user information based on other input information such as team record, team location, and other inputs. For example, if a user is part of a team, and the administrator of the team updates the team record or availability, that player's user profile may also show the updated team information.

The present invention provides a method in which players, coaches, and administrators may communicate quickly and easily. The present invention collects and presents information to the user to be able to provide information updates including but not limited to game date, location, timing, duration, opposing team, and other relevant information related to scheduling or alerts. The application provides a method for users to stay up to date with changing times, locations, and other logistics associated with sports scheduling. Additionally, the application includes an optional function in which a coach, administrator, team member, parent, or other member may be able to communicate with the team, referee, or point of contact on an opposing team in a messenger service. The communication function of the present invention is designed to allow users to quickly, easily, and broadly communicate with members to share important information, that may change quickly. The communication function allows the user to alert a plurality of individuals at once without having to individually call, text, or otherwise make contact with each individual. The function also allows a user to contact a referee or administrator of a facility or field in order to book, cancel, move, pay, or perform other functions related to the scheduling and booking of referees and field/facilities.

The present invention provides a matching function wherein a coach, administrator, or other team coordinator can selectively offer to play or accept another team to play against in a scrimmage, match, joint practice, or other engagement. The matching function may have a number of data points to provide deductive matching utilizing artificial intelligence, algorithms, or other methods of selectively presenting teams in a preferential manner. The deductive matching may use a variety of data points such as the sport, location, age group, team strength, team classification, league, team rating, travel radius, and other information to present potential matches in a preferential order.

A user may preferentially select, search, or prioritize other teams to play against based on team attributes and characteristics. The team attributes and characteristics may be input by the teams themselves or collected by other inputs into the mobile application. For example, a coach or administrator may input the sport, number of players, age group, and other statistics. Additionally, the mobile application may receive other inputs, such as the results of matches from other sources, or other data. Teams or opponents may be selected for matches via the matching function based on these adaptive characteristics. The mobile application may also provide a method of sorting, organizing, or otherwise presenting teams to a user to select the team that meets the desired criteria for an opposing team. The present invention then allows for the ability for a coach or administrator to send a communication or alert to the other team to request or propose a scrimmage, match, or other event.

The present invention includes a referee selection function. A user may search for referees with various preferences, including but not limited to date and time availability, certifications, location, travel distance, cost, and other preferences. The referee selection function also includes a method of payment in which the team or teams can pay for the referee's services. The referee may then collect their fee through the use of the application and connection with the referee's bank or with integration of another application or payment service.

The present invention includes a field or facility selection function. The facility selection function allows a team administrator to check the availability of facilities. The function also provides a method of booking the facility and alerting the facility administrators that a booking has been made. The team administrator is able to search based on facility attributes, including but not limited to, field or facility type (for example, a soccer pitch, ice rink, practice facility, or other types), date, time, cost, and other attributes or preferences. The facility may then be selected and a communication or alert sent to the facility administrator. Depending on the requirements of the facility, the mobile application will then facilitate the requirements needed to complete the booking and reserve the facility for the date and time specified. For example, some facilities require approval and payment. The mobile application allows for the communication to confirm the booking and make payment if necessary. Some facilities may require only a booking confirmation. The mobile application is designed to facilitate all necessary communication, confirmations, or payments needed to book a facility.

The present invention includes a league creator function. The league creator function allows administrators to build and format leagues. Teams can be selected, requested, or suggested to join a league. The league creator function takes input results from wins, losses, or ties, goals or points scored, and various other relevant information, including statistical information, to track during league play. The mobile application optionally enables various league functions such as the generation of schedules, suggested match-ups, individual and team statistics tracking. The invention also provides a method of creating and coordinating spontaneous games or matches, typically known as “pick-up games.”

The present invention, generally, is a sports team mobile application system and method wherein the user can perform a plurality of functions related to the administration and coordination of a sports team and its activities. The system is a downloadable computer program configured to operate on a mobile communication device and configured to access the internet. The system also includes a database of information accessible through the mobile communication device, wherein the information of the database includes a variety of information needed for the administration and coordination of a sports team, including but not limited to information such as the type of sport, personal information of players, location of players and teams, referee availability, facility availability, and other relevant information.

The present invention, depending on the specific features implemented and utilized, provides at least a portion of the functions listed herein with some being optional, as noted. Various embodiments of the present invention may be capable of utilizing artificial intelligence and other computer-driven decision making to enhance the user experience. Other technical advantages will be readily apparent to one skilled in the art.

### BRIEF DESCRIPTION OF THE DRAWINGS

FIG. 1 is a depiction of the interface showing the main screen of the mobile application of the present invention.

FIG. 2 is a flowchart of the selections of functions the present invention.

FIG. 3 is a flowchart of the matching function.

FIG. 4 is a depiction of the interface showing the matching function.

FIG. 5 is a depiction of the interface showing the results of the matching function search.

FIG. 6 is a flowchart of the referee selection function.

FIG. 7 is a depiction of the interface showing the referee selection function.

FIG. 8 is a flowchart of the facility selection function.

FIG. 9 is a depiction of the interface showing the facility selection function.

FIG. 10 is depiction of the computer functions of the present invention.

FIG. 11 is a depiction of the interface of the messages of the communication function.

FIG. 12 is a depiction of the interface of the notifications of the communication function.

FIG. 13 is a depiction of the interface of the account creation screen of the present invention.

FIG. 14 is a depiction of the interface of the game results of the present invention.

FIG. 15 is a flowchart of the optional spontaneous game function.

### DETAILED DESCRIPTION OF THE INVENTION

The present invention is a system and method configured to enable users to selectively search data sets related to the administration of sports teams. The present invention also provides a system and method configured to enable users to request or accept matches, services, or facilities, or communicate with other users. The present invention is designed to provide an easy and efficient way of accessing information related to the administration of sports teams. This may include building a roster of players, identifying potential opposing teams, searching for, requesting, and paying referees, searching for, requesting, and paying for facility bookings, and communicating with other users. The present invention also streamlines a number of historically manual tasks required with administering a sports team.

The system is embodied in a computer program arranged to implement the method in a computer system. The computer system is one or more discrete computer processor devices. Examples of known computing devices that may be suitable for use with the invention include, but are not limited to, personal computers, server computers, hand-held or laptop devices, cellular phones including smart phones, multiprocessor systems, microprocessor-based systems, set top boxes, programmable consumer electronics, network PCs, minicomputers, mainframe computers, distributed computing environments that include any of the above systems or devices, and the like. The computer system may include computer devices operated by one or more users, such as through a desktop, laptop, or servers, and/or one or more providers of services corresponding to one or more functions of the invention. While users may primarily access the invention via mobile device such as a smart phone, it is not limited thereto.

The server, the computer processor, or a combination of both may be programmed to include one or more of the functions of the invention system. One or more relational databases that may be associated with the server, the computer processor, other computing devices, or any combination thereof, include information related to the use of the invention system. For example, the database includes information associated with a specific team, such as its location, age group, and competitive level. The database of the present invention is used for gathering, storing and making accessible information related to the administration of sports teams. For the purpose of the description of the present invention, a database is a collection of stored data that are logically related. Although there are different types of databases, and the database of the present invention may be any of such types, it is preferably a relational database with a relational database management system, comprising tables made up of rows and columns. Data stored in the relational tables are accessed or updated using database queries submitted to the database system. The database may be populated and updated with information provided by an application provider capable of carrying out one or more of the steps associated with the system of the invention, such as MySQL, or any other information providers.

The invention may be described in the general context of computer-executable instructions, such as program modules, being executed by a computer. Generally, program modules include routines, programs, objects, components, data structures, etc. that perform tasks or implement abstract data types. As indicated above, the system of the present invention may also be practiced in distributed computing environments where tasks are performed by remote processing devices that are linked through a communications network or other data transmission medium. In a distributed computing environment, program function modules and other data may be in both local and remote computer storage media including memory storage devices. Storage of program instructions and database content may thereby be cloud-based as they can be stored on remote servers and accessed through internet-based connections, such as Amazon Web Services, or any other database providers.

The computer processor and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. The computer system typically includes a variety of computer readable media. Computer readable media can be any available media that can be accessed by the computer system and includes both volatile and non-volatile media, removable and non-removable media. By way of example, and not limitation, computer readable media may be computer storage media and communication media. Computer storage media includes volatile and non-volatile, removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system. The computer system further includes computer storage media in the form of volatile and/or non-volatile memory such as Read Only Memory (ROM) and Random Access memory (RAM). RAM typically contains data and/or program modules that are accessible to and/or operated on by the computer processor. That is, RAM may include application programs, such as the functional modules of the system of the present invention, and information in the form of data. The computer system may also include other removable/non-removable, volatile/non-volatile computer storage and access media. For example, the computer system may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor. A user may enter commands and information into the computer processor through input devices such as a keyboard, a touchpad or a pointing device such as a mouse. Other input devices may include a microphone, joystick, game pad, satellite dish, scanner, or the like. These and other input devices are connected to the computer processor through the system bus, or other bus structures, such as a parallel port, game port or a universal serial bus (USB) but is not limited thereto. A monitor or other type of display device is also connected to the computer processor through the system bus or other bus arrangement.

The computer processor may be configured and arranged to perform the described functions and steps embodied in computer instructions stored and accessed in any one or more of the manners described. The functions and steps, such as the functions and steps of the present invention described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor, instruct the computer processor to perform one or more processes or acts described herein, and/or various examples, variations and combinations thereof. Such instructions may be written in any of a plurality of programming languages, for example, XML, Java, JavaScript, Visual Basic, C, or C++, and the like, or any of a variety of combinations thereof. The computer-readable medium on which such instructions are stored may reside on one or more of the components described above and may be distributed across one or more such components, such as Laravel, React Native, or other component or web framework.

The present invention 10 is a computer or mobile phone application which provides a plurality of functions 12 to aid in the administration of a sports team. The present invention 10 collects and stores data for use in a matching function 22, an referee selection function 40, an facility request function 50, an league creation function 60, an communication or messaging function 70, an administration 80 function, and an optional spontaneous game function 90. The functions 12 of the present invention 10 may be selectively utilized as needed. It is a design of the present invention 10 to provide a singular application wherein a team administrator or coach may be able to search a database 106 for players, teams, referees, or facilities, record and review game results, pay for certain services, communicate with other individuals like players, coaches, or other types of administrators, and send and receive notifications related to various team administration functions.

The present invention 10 has the capability to receive, store, and organize data related to sports team activities. This may include information such as player information, coach information, locations information, game results, various contact information, and other such data. The data may be sortable and searchable for the user. The data collection may come from a variety of sources, namely, the users themselves. The data may be stored in the mobile application 10 or in a network or cloud 104 and is readily accessible to users.

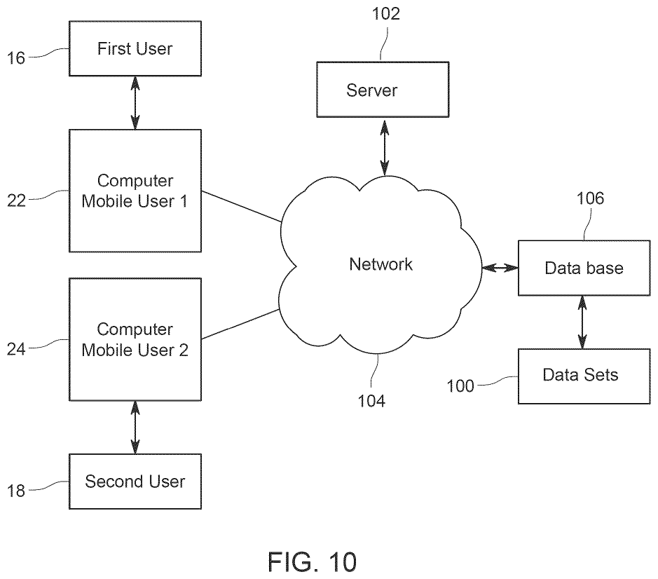

The data collected by the application 10 may utilize artificial intelligence, algorithms, and other methods of organizing the data into a plurality of useable data sets 100. The data sets 100, represented simply in FIG. 10, are used to provide potential matches for each of the functions 12 of the present invention 10. The functions 12 may suggest or identify potential data sets 100 which match user-selected search parameters or computer-generated suggested. The mobile application 10 may also suggest potential matches or pairings based on artificial intelligence or algorithms as determined by the application 10.

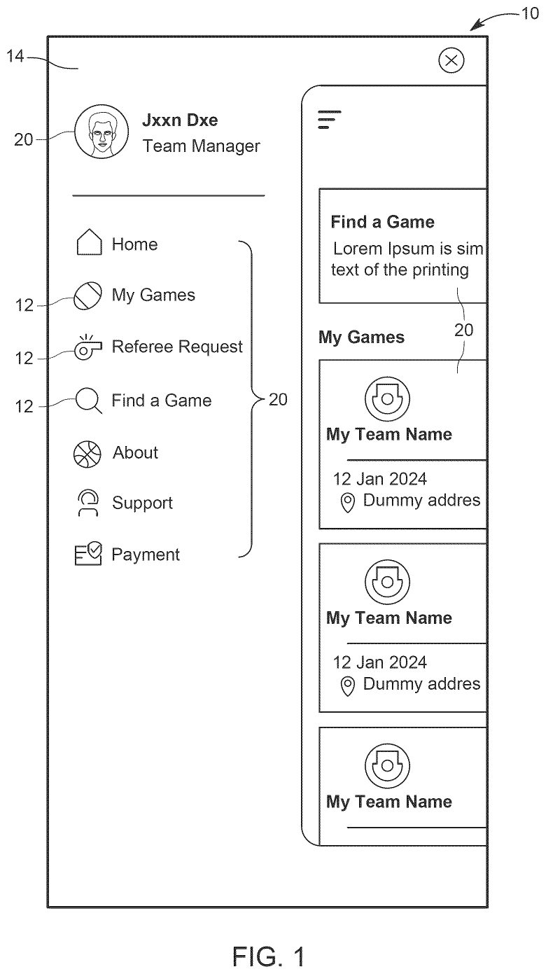

FIG. 1 depicts an initial interface 14 of the present invention 10. The interface 14 has a plurality of selections 20 which control how a user uses the application 10. The selections 20 may include, but are not limited to, the matching function 22, referee selection function 40, facility request function 50, league creator function 60, communication function 70, or administration function 80. The application 10 may also have an optional referee payment function 44 or an optional facility payment function 58. A user may navigate the application 10 by selecting one or more functions 12 by clicking on the associated link.

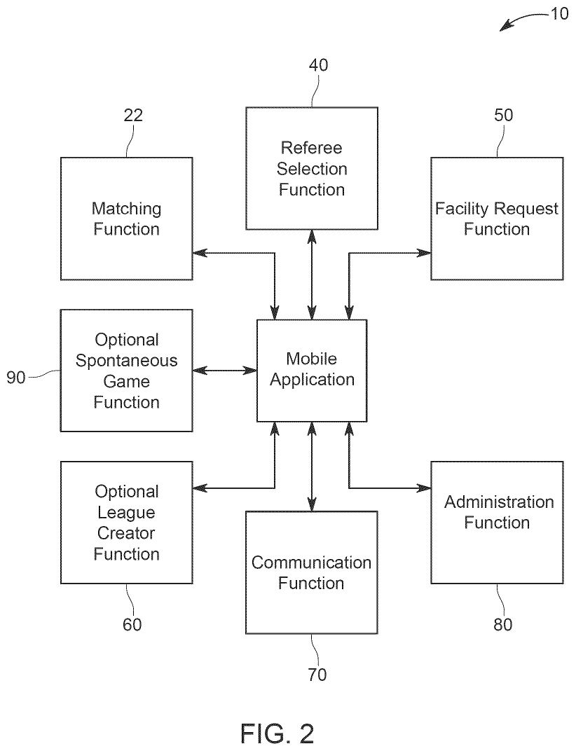

FIG. 2 depicts the functions 12 available to the user. Once in the application 10, the user may select one or more of the of functions 12, including the matching function 22, referee selection function 40, facility request function 50, league creator function 60, communication function 70, and administration function 80. Selection of one of the functions 12 by clicking on the associated link seen in the user interface initiates the use of the selected function. For example, if the user selects the matching function 22, the matching function 22 may generate and present a data set 100 to the user suggesting potential teams to match with. Selecting the matching function 22 may also generate a request for the user to selectively input search parameters or prioritize team attributes with which to generate a data set 100 of search results.

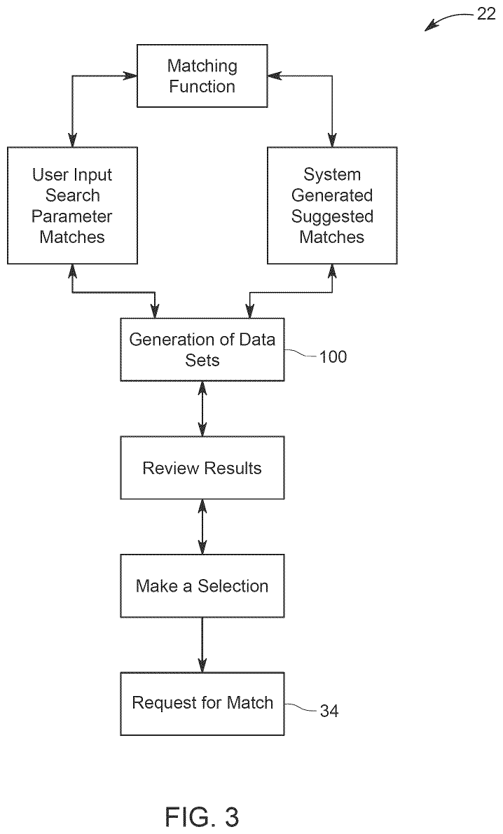

FIGS. 3-5 show the use and depiction of the matching function 30. FIG. 3 depicts a flowchart of the matching function 22. The matching function 22 may be selected from the interface 14. The matching function 22 is designed to generate a plurality of team data sets 100 from which the user may select. The team data sets 100 may be automatically generated by the application 10 using artificial intelligence or algorithms. Alternatively, the team data sets 100 may be generated based on user-input preferences and priorities. The user may then select a team from the data set 100 to review the team attributes or request an activity. The requested activity may be for a game, scrimmage, joint practice, or other type of activity with the selected team.

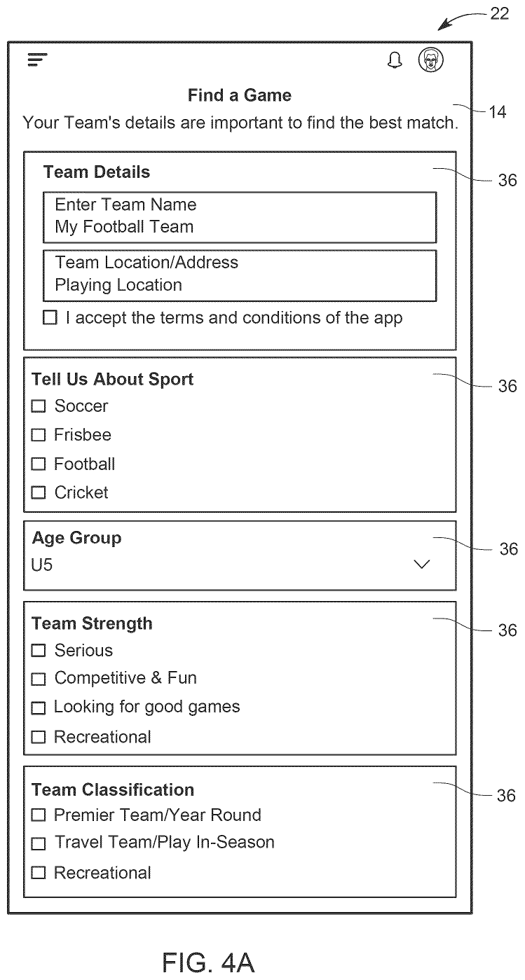

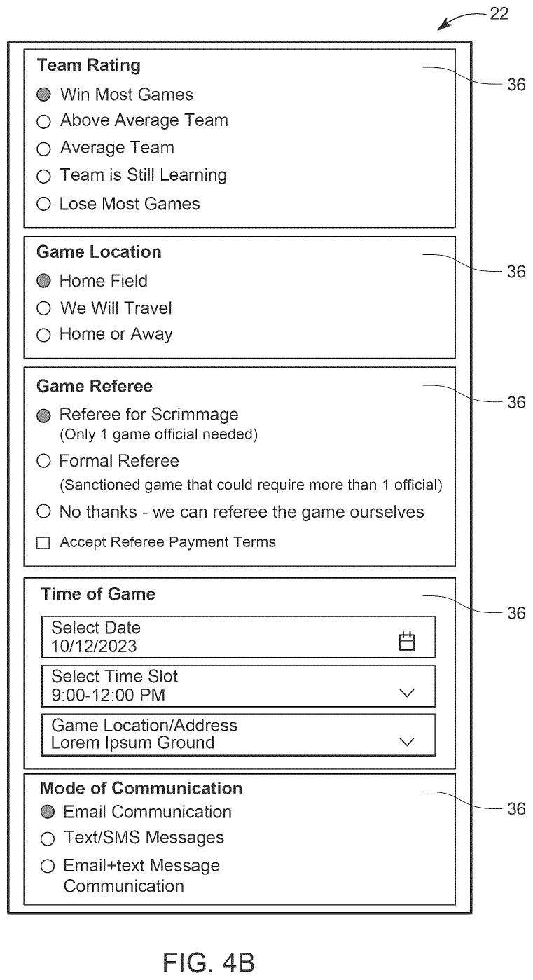

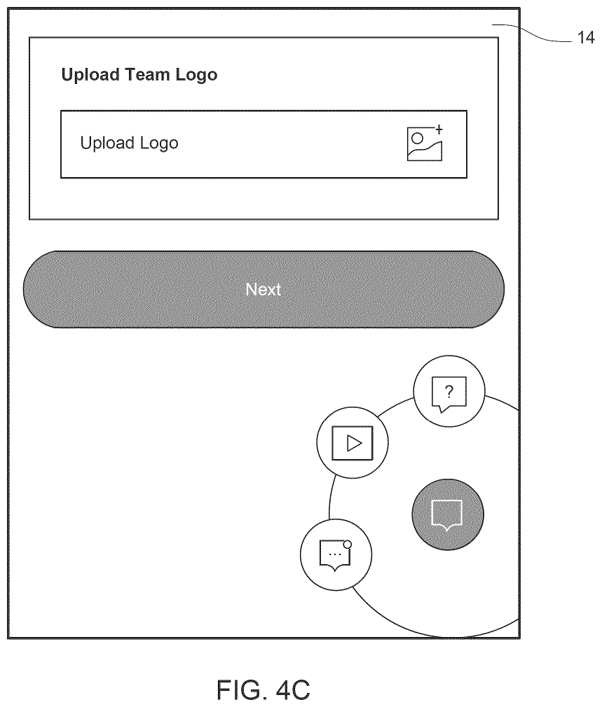

FIGS. 4A-4B depicts a user interface screen for the matching function 22 of the present invention 10. The matching function 22 allows the user to selectively find appropriate matches based on certain team characteristics. For example, if a coach is attempting to schedule a scrimmage with another team, the coach may want to select an opposing team which is located within a certain radius of the coach's team. The coach may also want to select an appropriate age group for the match such that one team of 8-year-olds does not get matched with a team of 17-year-olds, for example. The matching function 22 presents the user with the team data set 100 consisting of a number of teams organized by team attributes that may be a suitable match. The data set 100 may be generated automatically by the application 10 or by the user searching for teams using a selection or prioritization of team attributes 36. The team attributes 36 may consist of but are not limited to attributes like the sport, age group, team details, ratings, location, time of game, and other attributes 36. The user may select, prioritize, or organize the results based on the attributes 36 to find an appropriate or desired match. FIG. 4C depicts the interface 14 of the present invention 10 where the user may upload a team logo or other identifying feature. The logo or feature may be used to personalize the application or be used to easily identify other teams.

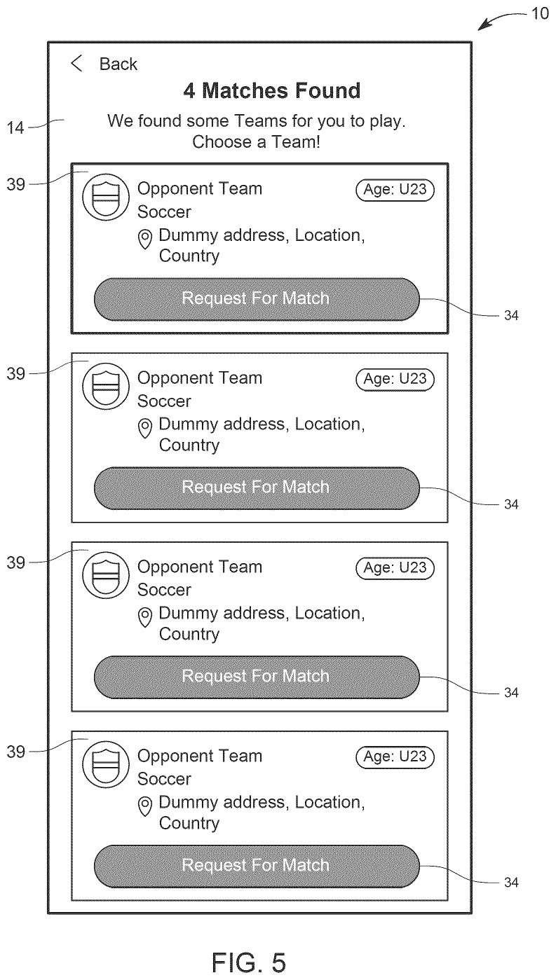

FIG. 5 depicts the results of searching for a team of the team data set 100 using the matching function 22. The data set 100 represented in the user interface includes a list of teams 39 shown based on the parameters of the search. The search results may be generated by artificial intelligence or algorithms of the present invention 10, or with user-input search parameters. The mobile application 10 presents the search results in a selectable format wherein the user may scroll or sort through the results to find a desired match. The matching function 22 has a method in which two users may contact each other or request a match. The search results or suggestions from the matching function 22 have a request for match feature 34. The request for match feature 34 is initiated by a first user 16 and received by a second user 18, which may be represented as the opponent team. The first user 16 is presented with the search results of the matching function 22. The first user 16 may select the request for match feature 34, whereby the application 10 sends a request through the network 104 to the second user 18. The second user 18 may receive a message, notification, or otherwise be informed of a pending request through the mobile application 10. The second user 18 may choose to accept, decline, or not answer the request. FIG. 5 depicts the interface 14 of the present invention 10 showing a list of teams whereby the user may select a team to request a match based on the team attributes 36. The teams may be organized by age group, location, or other attributes 36. The user selects the desired team to play again, and requests a match against the selected team by selecting the corresponding request for match 34 feature.

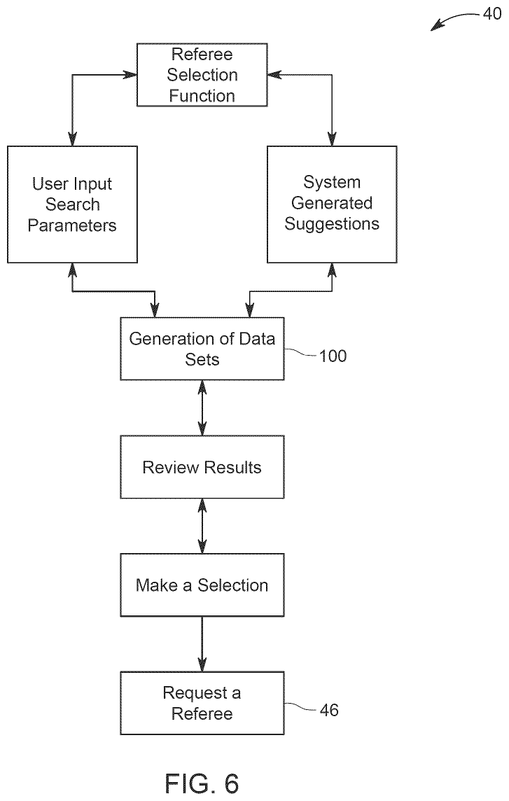

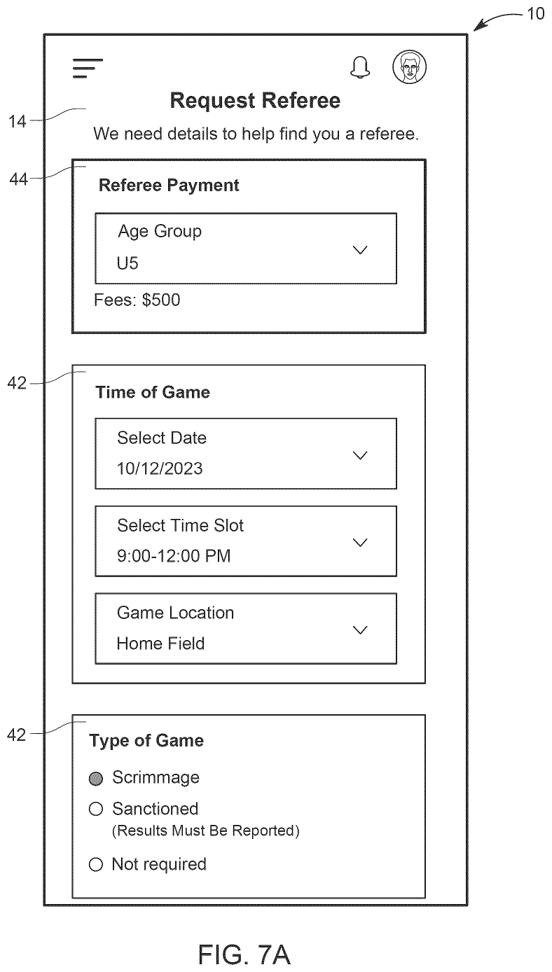

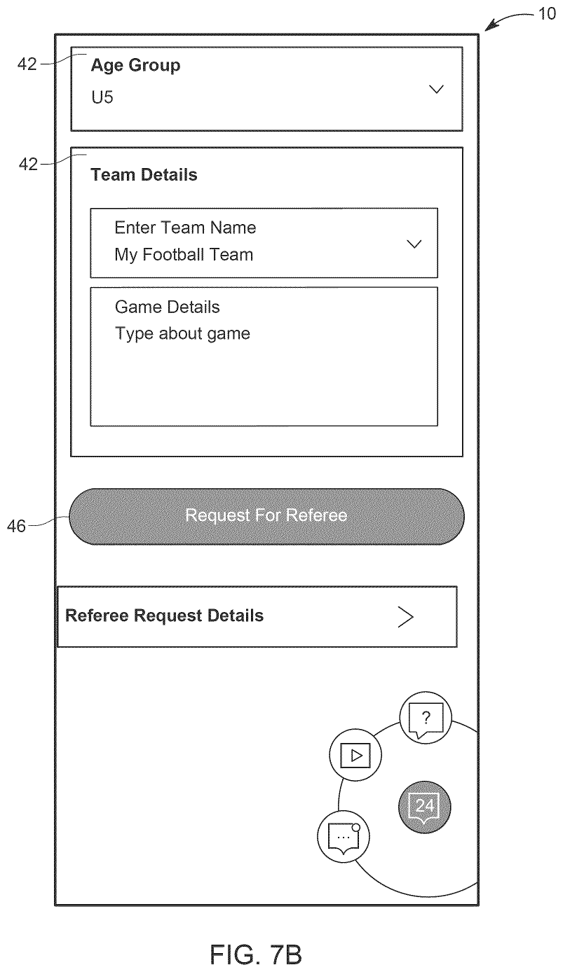

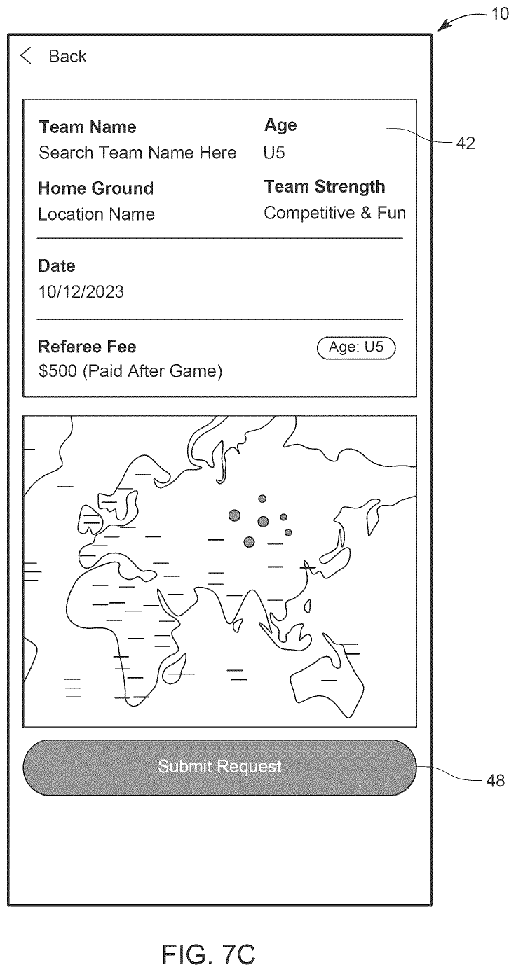

FIGS. 6-7C show the use and depiction of the referee selection function 40. FIG. 6 depicts a flowchart of the referee selection function 40. The referee selection function 40 may be selected from the interface 14. The referee selection function 40 is designed to generate a referee data set 42 of available referees from which the user may select. The referee data set 42 may be automatically generated by the application 10 using artificial intelligence or algorithms. Alternatively, the referee data set 42 may be generated based on user-input preferences and priorities. The user may then select a referee from the referee data set 42 to review the referee profile and availability.

FIGS. 7A-7C depicts a user interface for the referee selection function 40 of the present invention 10. The referee selection function 40 allows the user to selectively find available referees based on certain characteristics. For example, if a coach is attempting to schedule a game with another team, the coach may want a certain number of referees to attend. The coach may also want to select the referee(s) based on certain parameters, such as location, availability, certification level, years of experience, or other characteristics. The referee selection function 40 presents the user with information pulled from the referee data set 42 including, for example, a number of referees organized by various attributes that may be useful or desired by the coach or team. The referee data set 42 may be generated automatically by the application 10 or by the user searching for referees using a selection or prioritization of referee characteristics. The user may review the referee attributes and submit a request for a referee using a request for referee selection 46. The application may generate a summary of the referee request, and the request may be completed by selecting a submit request feature 48.

The present invention 10 may have an optional referee payment function 44. The referee payment function 44 allows the user to pay for referee services through the mobile application 10. The referee payment function 44 may connect to a user's bank account, credit card, third party payment provider, or other such method of making a payment. The referee payment function 44 provides for a direct method for coaches or team administrators to pay referees for their services.

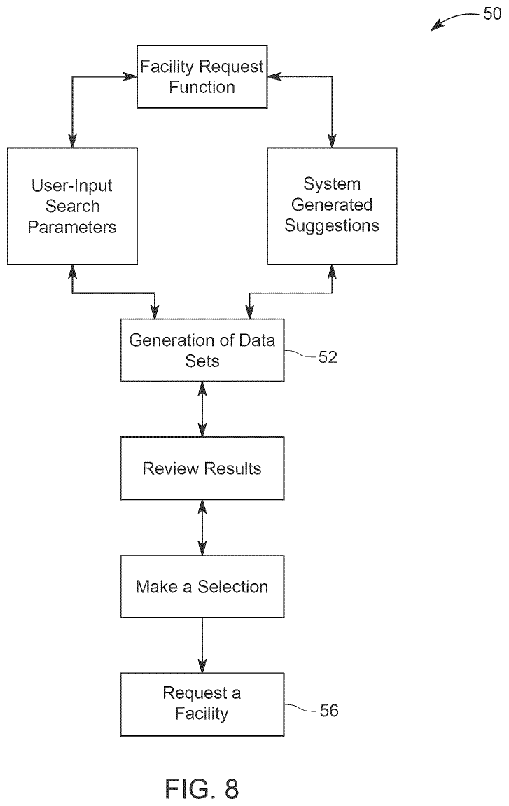

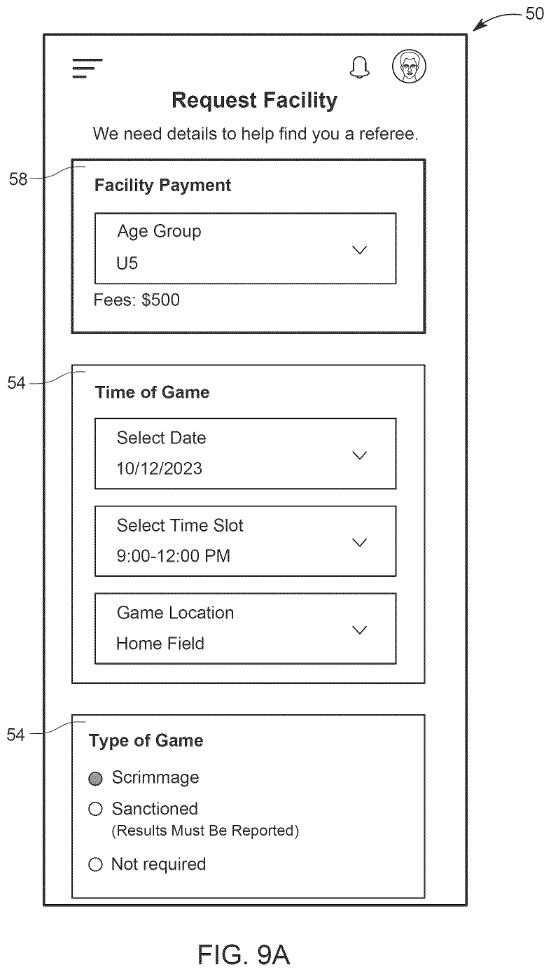

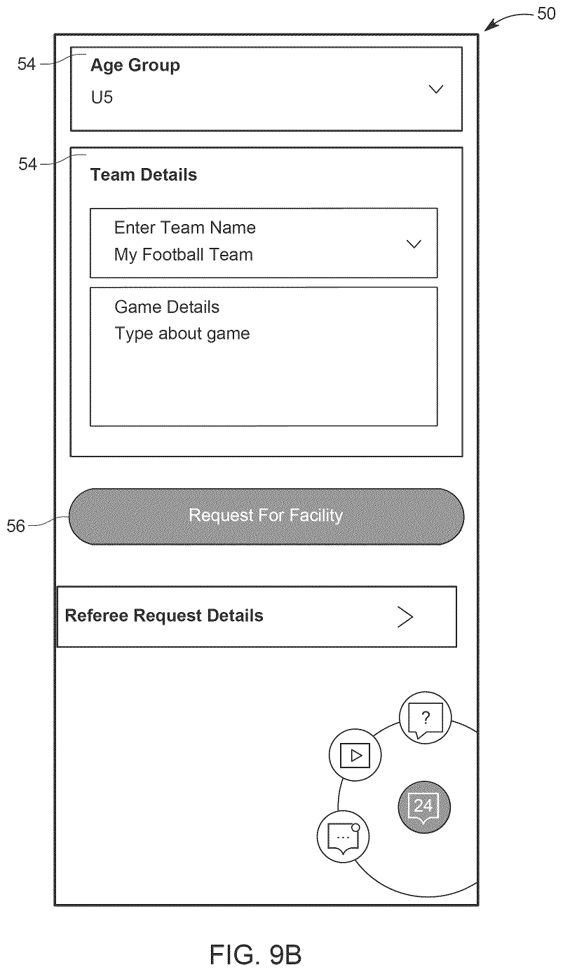

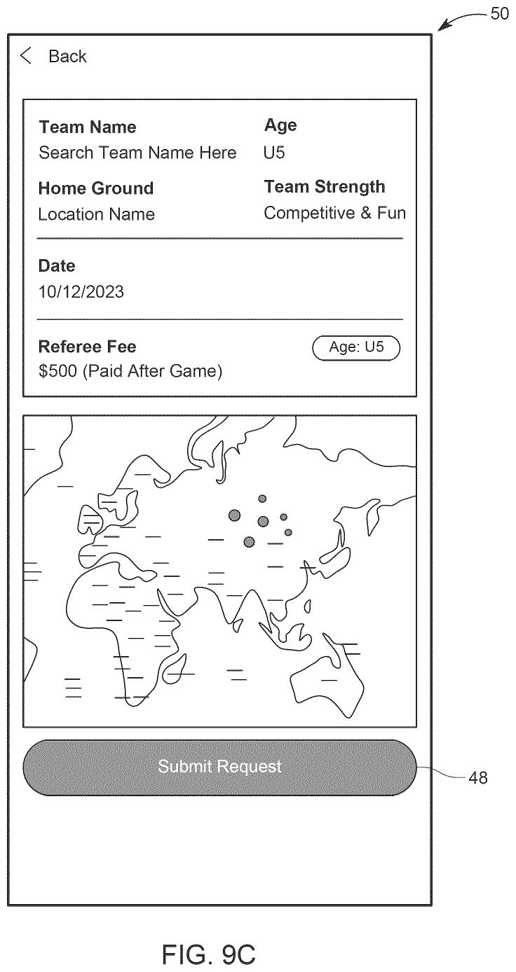

FIGS. 8-9 show the use and depiction of the facility request function 50. FIG. 8 depicts a flowchart of the facility request function 50. The facility request function 50 may be selected from the interface 14. The facility request function 50 is designed to generate a facility data set 52 of available facilities from which the user may select. The facility data set 52 may be automatically generated by the application 10 using artificial intelligence or algorithms. Alternatively, the facility data set 52 may be generated based on user-input preferences and priorities. The user may then select a referee from the facility data set 52 to review the referee profile and availability. The facility request function 50 may have a variety of types and locations of facilities. For example, the facility data set 52 may include indoor training facilities, public fields, private fields, and other such facilities that may be suitable for playing games, holding practices, training, or other activities related to the administration of a sports team.

FIGS. 9A-9C depicts the facility request function 50 of the present invention 10. The facility request function 50 allows the user to selectively find available facilities based on a plurality of facility characteristics 54. For example, if a coach is attempting to schedule a soccer game with another team, the coach may want an outdoor soccer field with specific size requirements. The coach may select certain parameters, such as location, field type, field size, or other characteristics 54. The facility request function 50 presents the user with a facility data set 52 consisting of a number of fields organized by various attributes that may be useful or desired by the coach or team. The facility data set 52 may be generated automatically by the application 10 or by the user searching for facilities using a selection or prioritization of facility characteristics 54. The user may then select the desired facility and the request may generate a summary by selecting a request for facility 56. The request may then be completed by selecting the submit request feature 48.

The present invention 10 may have an optional facility payment function 58. The facility payment function 58 allows the user to pay for the use or booking of a facility through the mobile application 10. The facility payment function 58 may connect to a user's bank account, credit card, third party payment provider, or other such method of making a payment. The facility payment function 58 provides for a direct method for coaches or team administrators to pay for the use or booking of a facility.

The present invention 10 may have an optional league creator function 60. The league creator function 60 may be used to select a number of teams to create a league. The league may be comprised of a plurality of teams selected by a user. The league creator function 60 provides a method in which a user may create a league to set up a schedule of games, record and update standings, report game results, record statistics, and manage other league functions.

FIG. 10 depicts a simplified block diagram of the present invention 10 interaction between a first user device 22, a second user device 24, the cloud or network 104, and the server 102. The server 102 facilitates the connections between the first user device 22, the second user device 24 and the cloud or network 104. The cloud or network 104 retains the data and collected information from the mobile application 10. The first user device 22 or the second user device 24 may interact with only the cloud or network 104 for various purposes including looking up information related to teams, players, facilities, referees, and other information. Additionally, the first user device 22, the second user device 24 may interact with each other as well as the cloud or network 104. These interactions may include game requests, referee requests, administrator requests, communications, and other interactions. Some of all of the specific data sets listed herein may be contained in the broader data set as depicted in FIG. 10.

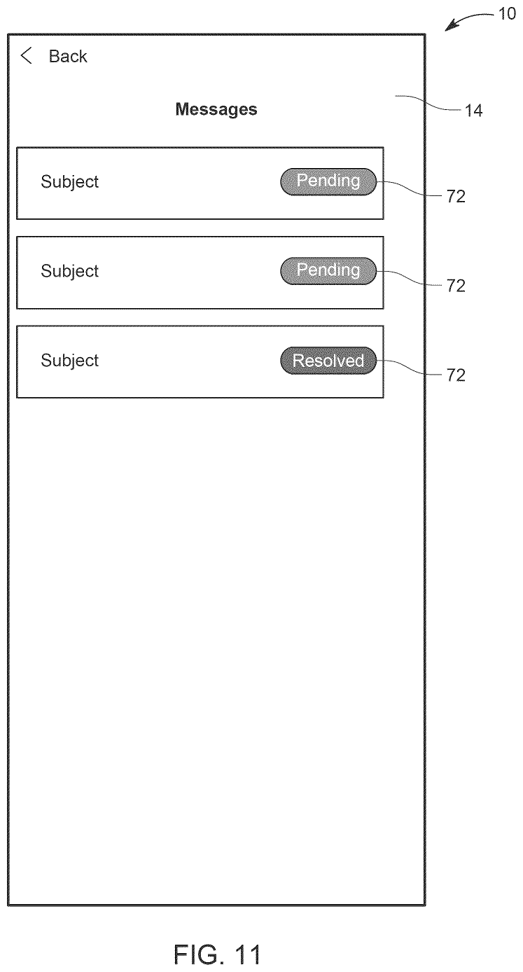

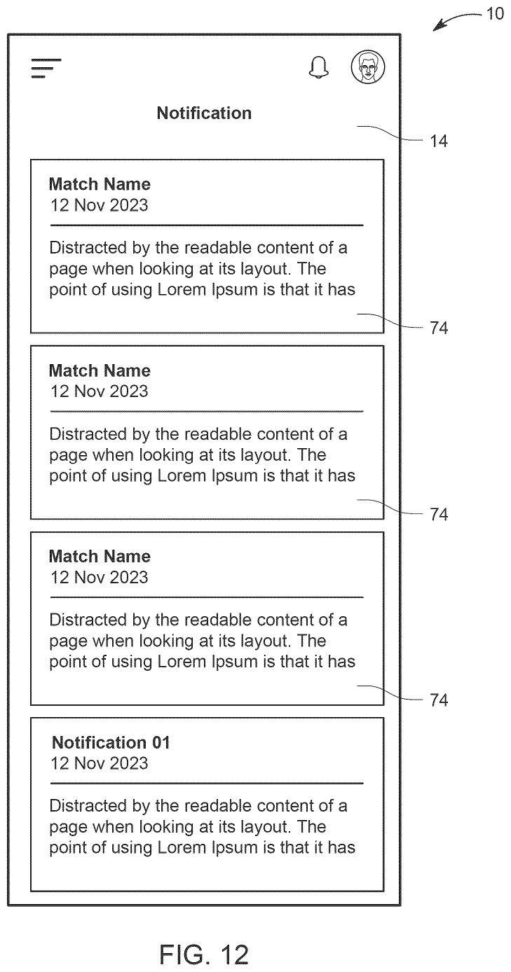

FIGS. 11-12 depict the interface 14 of the communication function 70 of the present invention. The communication function 70 provides a method in which a plurality of users may contact one another for various reasons. The communication function 70 may be in the form of a message 72 or a notification 74. A user may choose through the first user device 22 to contact another team's representative, referee, facility administrator, or other user via the second user device 24. For example, a user may wish to request a certain game format be played from a second user. A message 72 of the communication function 70 may be an optimal way to communicate the information from one user to another. In another example, a user may want to alert another user that a match request or a referee request has been confirmed. A notification 74 of the communication function 70 may be an optimal way to alert another user of such. Additionally, the mobile application 10 may generate messages 72 or notifications 74 to user for various purposes.

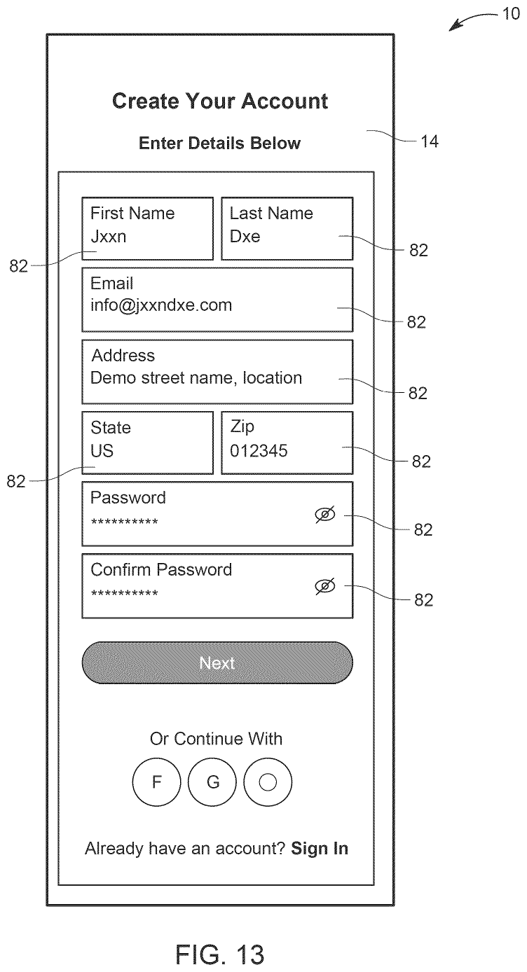

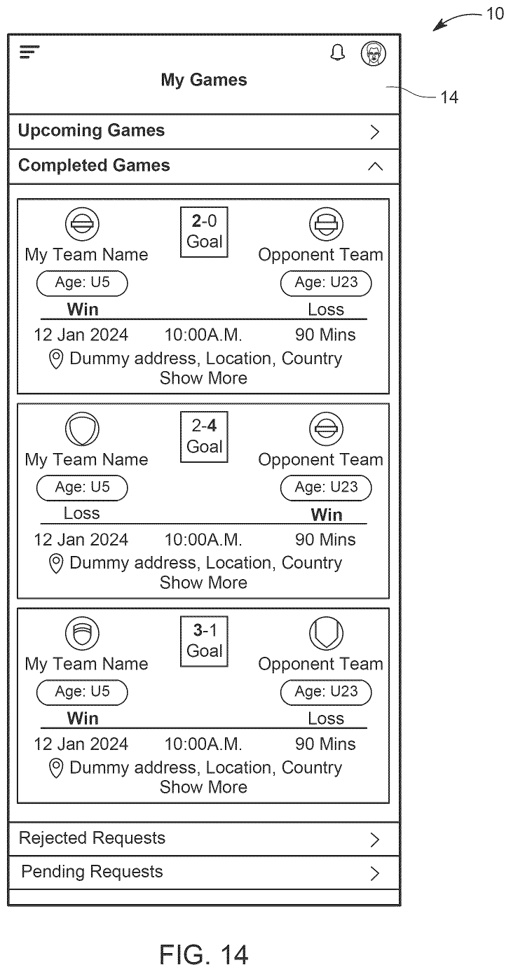

FIGS. 13-14 depict the interface 14 of the administration function 80 of the present invention 10. The administration function 80 provides a method of managing a plurality of administrative settings 82, such as the account, passwords, login information, and various other administrative information. FIG. 13 depicts the interface 14 wherein the user is prompted to create an account. The account information may include a variety of required or information to complete the sign-up or login-in process. FIG. 14 depicts the interface 14 wherein the user is able to view various information within the mobile application 10. The information may be comprised of various information input, uploaded, or otherwise collected by the present invention 10. This information may be statistics, game results, upcoming games, and a wide variety of other information.

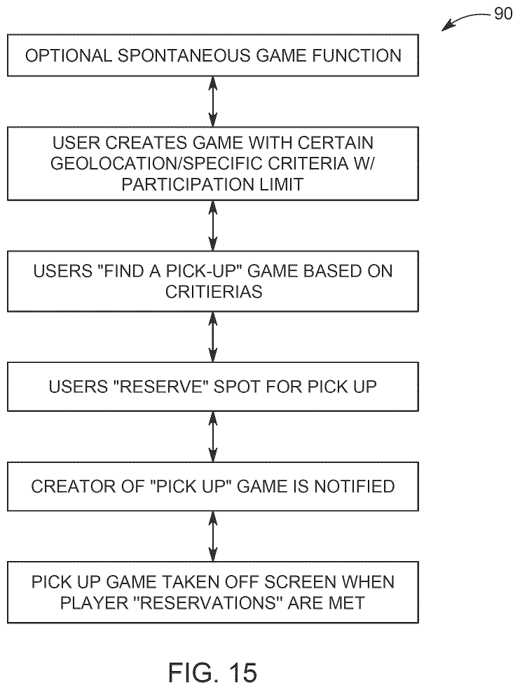

FIG. 15 is a flowchart of the optional spontaneous game function 90. The spontaneous game function 90 may be used to organize and alert users of a spontaneous game (known as a “pick-up game”). The spontaneous game function 90 may be used by a user to set up a spontaneous game with certain characteristics including, for example, a certain time, date, location, or cost. Other users may receive a notification of the creation of such a game and be able to sign up through the present invention 10. The present invention 10 may then perform various tasks related to the coordination, set up, and administration of the game, such as, confirm participants, request, receive, or make a payment, form a waiting list, or perform other tasks as necessary.

The present invention 10 is a computer implemented system designed to facilitate the administration of a sports team, namely, to suggest or provide potential matches for games, scrimmages, or other activities, to find or suggest referees or umpires, and to perform other administrative functions. Although several embodiments have been illustrated and described in detail, it will be recognized that substitutions and alterations are possible without departing from the spirit and the scope of the claims. Modifications, additions, or omissions may be made to the functions 12, interface 14, or other features of the present invention 10 without departing from the scope of the disclosure.

What is claimed is:

1. A computer implemented method of collecting and presenting information related to sports team administration, the method comprising:
electronically gathering a plurality of sports team profiles, the profiles comprising of a plurality of team attributes;
electronically compiling team data sets of sports team profiles from various sources;
a first user selecting a function request;
displaying said team data set of said plurality of team attributes;
reviewing team data sets;
the first user selecting a second user for a request from the team data sets based on the plurality of team attributes; and
transmitting a request to the second user;
wherein the plurality of team attributes is collected from a variety of users; and
wherein the team data set is sortable by said plurality of team attributes.

2. The method of claim 1 wherein the function request is a matching function request.

3. The method of claim 2 wherein the computer, through artificial intelligence, algorithms, or other method suggests a team data set to the first user.

4. The method of claim 2 wherein the first user selects or prioritizes team attributes to selectively generate team data sets.

5. The method of claim 2, further comprising:
electronically requesting a scrimmage, a match, a joint practice, or other inter-team activity for access by the second user;
the second user electronically receiving said electronic request; and
the second user responding to the request.

6. The method of claim 5, further comprising the step of providing the first user with an option to request a referee for the scrimmage, match, joint practice, or other team activity.

7. The method of claim 6, further comprising the steps of:
the first user electronically submitting a referee request;
the first user receiving a referee data set based on requested preferences;
the first user selecting a referee from the referee data set;
the first user electronically sending a request to the referee; and
enabling the referee to receive and respond to the electronic request.

8. The method of claim 7, further comprising:
enabling the first user to electronically submit a payment for the requested services.

9. The method of claim 1 wherein the function request is a facility request.

10. The method of claim 9, further comprising:
the first user electronically submitting a facility request;
the first user receiving a facility data set based on requested preferences;
the first user selecting a facility from the facility data set;
the first user electronically sending a request for the facility; and
enabling a facility administrator to receive and respond to the electronic request.

11. The method of claim 10, further comprising:
said first user electronically submitting a payment for the requested services.

12. The method of claim 1 wherein the function request is a league creation request.

13. The method of claim 12, further comprising:
the first user electronically submitting a league creation request;
the first user receiving a team data set based on requested preferences;
the first user selecting a plurality of teams from said team data set;
the first user electronically sending a request to each selected team;
an administrator from each selected team receiving said electronic request; and
the administrator responding to the request.

14. A mobile communication system including a mobile communication device configured to carry out through processor executable instructions using computer-implemented functions to improve operation of the computing system to enable a user to facilitate the administration of a sports team to conduct a sporting activity, the system comprising:
a computer program configured to operate on the mobile communication device through the processor and configured to access the internet and having stored thereon computer-executable instructions configured to cause the computer device to implement instructions;
a database of information accessible through the mobile communication device, wherein the information of the database includes data sets related to team sports administration in the form of player characteristics, team characteristics, referee characteristics, facility characteristics, and other administrative data related to administering a sports team;
a matching function wherein a user is presented a team data set based on user-input preferences to facilitate the sporting activity;
a request function configured to enable the user to make a sporting activity request; and
a communication function configured to enable the user to submit the request to an interested party.

15. The system of claim 14 wherein the request is a game request and the interested party is a potential opponent.

16. The system of claim 14 wherein the request is a referee request and the interested party is a referee.

17. The system of claim 14 wherein the request is a facility request and the interested party is a facility manager.

18. The system of claim 14 wherein the request is a league creator request and the interested party is an administrator of the computer program.

19. The system of claim 14 wherein the communication method allows a user to communicate with a plurality of other users.
